(19) United States
(12) Patent Application Publication
(10) Pub. No.: US 2014/0191059 A1
(43) Pub. Date: Jul. 10, 2014

(54) NOZZLE CAPABLE OF DEVIATING A SYNTHETIC JET IN A DYNAMIC AND CONTROLLABLE MANNER WITH NO MOVING MECHANICAL PARTS AND A CONTROL SYSTEM THEREOF

(71) Applicants: Federica Baffigi, Livorno (IT); Antonio Dumas, Bologna (IT); Ilaria Giuliani, Cadelbosco Sopra (IT); Mauro Madonia, Budrio (IT); Michele Trancossi, Parma (IT)

(72) Inventors: Federica Baffigi, Livorno (IT); Antonio Dumas, Bologna (IT); Ilaria Giuliani, Cadelbosco Sopra (IT); Mauro Madonia, Budrio (IT); Michele Trancossi, Parma (IT)

(73) Assignee: UNIVERSITA' DEGLI STUDI DI MODENA E REGGIO EMILIA, MODENA (IT)

(21) Appl. No.: 14/129,712

(22) PCT Filed: Jun. 25, 2012
(86) PCT No.: PCT/IB2012/053198

§ 371 Date: Mar. 12, 2014

(30) Foreign Application Priority Data
Jul. 1, 2011 (IT) RE2011A000049

(51) Int. Cl. B05B 1/00

(52) U.S. Cl. CPC B05B 1/005
USPC 239/11; 239/543

(57) ABSTRACT

A nozzle is capable of producing a mixing of two primitive fluid jets and a selective and controllable angular deviation of the synthetic jet obtained by mixing the primitive jets without any moving mechanical part. The nozzle is also capable of generating a controllable deviation of the synthetic jet and of changing the direction of this jet in a continuous and dynamic manner so as to allow the jet to sweep a preset and arbitrary angle. The nozzle is constituted, in a first part thereof, by a conduit divided into two channels by a central baffle and, in a second part thereof, by a convergence zone and an outflow mouth whose walls have a curvilinear profile and are connected seamlessly to the walls of the conduit.

### FIELD OF THE INVENTION

The object of the present invention is a nozzle capable of producing an angular deviation of a synthetic jet, with no moving mechanical parts, the synthetic jet being formed by mixing more than one primitive jet. The nozzle is also capable of modifying the direction of the synthetic jet in a dynamic manner.

The primitive fluid jets may be homogeneous, that is, equal in nature, physical state and temperature, or non-homogeneous and they can also undergo physical-chemical transformations by virtue of their mixing.

The deviation of the synthetic jet is due to the manner in which the primitive jets mix and to their interaction with the walls.

A suitably shaped nozzle allows such a synthetic jet to adhere to convex walls at the exit from the nozzle itself, in a manner depending on the momentum of the primitive jets (or on the speed, in the case of homogeneous jets) and on the geometry of the walls of the nozzle itself. The adhesion angle can be modified by means of any variation of the momentum of the primitive jets (or of the speed, in the case of homogeneous jets), obtained by means of any effect suitable for modifying the flow rate, temperature, velocity, pressure, composition and physical state of the primitive jets.

The nozzle, which is the object of the present invention, can produce an angular deviation of the synthetic jet that is constant or variable over time, by means of a variation in the momentum of the primitive jets and in a manner depending on the shape of the walls of the nozzle.

This invention offers multiple applications within the scope of industrial fluid dynamics, such as those listed herein below by way of non-comprehensive example: systems of deviation of the thrust of fluid jets, including naval and aeronautic propulsion; systems of diffusion of a fluid, including aeration and air-conditioning; thermal cutting systems with a blade of air; fluid jet cooling systems; systems for technological surface treatment procedures such as sandblasting, painting and deposition; combustion systems with adjustable flames.

The present invention is applicable to any industrial system in which having a fluid jet that can assume an arbitrary angular deviation, with respect to the axis of the nozzle, and which can be modified over time, constitutes an advantage with respect to known solutions.

### DESCRIPTION OF RELATED ART

The following elements are known: the definition of a Coanda surface as any convex surface that gradually projects from a nozzle in a continuous manner (curved profile), in a discontinuous manner (consequent flat faces that approximate a curved surface), or in any other combination of the cases indicated; the Coanda effect intended as the capacity of a fluid jet to adhere and maintain the condition of adhesion to a Coanda surface. Lastly, it is known that two fluid jets that are parallel and suitably close to each other spontaneously mix together in such a manner that the jet with greater momentum attracts the other jet towards it.

Based on the principles stated, nozzles that can produce a deviation of a fluid jet have been developed in the past, but they offer poor controllability. To increase the controllability of the jet, particularly complex and not always functional nozzles have been used with movable appendages, or with very high speed pilot jets, resulting in high costs, poor reliability and functional features that are not always adequate.

US 2009/0230209 discloses a device for controlling a jet, the device comprising a central conduit surrounded by a Coanda surface. A plurality of control conduits are arranged circumferentially around the central conduit, so as to be interposed between the Coanda surface and the central conduit. A primary jet exits the central conduit and, in normal conditions, it would move along a straight path. When a control jet is activated in a desired angular position, the control jet adheres to the Coanda surface and follows curvature thereof. This creates a low-pressure region, which attracts the primary jet towards the control jet along the Coanda surface, thereby generating a deviated jet.

The device disclosed in US 2009/0230209 is rather complicated because, in order to activate or deactivate a control jet, it is necessary to act on a pneumatic valve which controls the single control conduit. Since a high number of control conduits is provided, the device comprises a number of valves and is therefore relatively expensive and of difficult maintenance.

U.S. Pat. No. 5,894,990 discloses a device comprising a conduit for emitting a primary jet positioned at a side of a conduit arranged for emitting a control jet. The conduit which emits the control jet can be displaced backwards relative to the conduit emitting the primary jet, so that the outlet cross-section of the conduit emitting the control jet is in a less advanced position relative to the outlet cross-section of the conduit emitting the primary jet. By so doing, the control jet adheres to the walls of the conduit through which the primary jet passes, owing to the Coanda effect. The control jet consequently interacts with the primary jet, which is deviated.

A drawback of the device disclosed in U.S. Pat. No. 5,894,990 is that the control jet allows the primary jet to be deviated only towards one side, which implies that the primary jet exiting the device can only have a limited number of orientations.

### SUMMARY OF THE INVENTION

In this context, the present invention defines a nozzle with great simplicity and reliability, capable of controlling the angle of the jet both in a static and a dynamic manner, overcoming the limits of the prior art cited hereinabove.

In particular, an object of the present invention is to provide a nozzle capable of generating a controllable deflection of a synthetic jet formed by two primitive jets, without using pilot jets.

The defined technical task and the specified objects are substantially achieved by a suitably shaped nozzle comprising the technical features set out in one or more of the appended claims. In the nozzle according to the invention, if the momentum of the first fluid jet is greater than the momentum of the second fluid jet, the first fluid jet adheres to the first Coanda surface, i.e. to the Coanda surface adjacent thereto, the first jet thereby dragging with it the second jet and generating a synthetic jet deflected towards the first Coanda surface.

If on the other hand the momentum of the second fluid jet is greater than the momentum of the first fluid jet, the second fluid jet adheres to the second Coanda surface, i.e. to the Coanda surface adjacent thereto, the second fluid jet thereby dragging with itself the first jet.

Consequently, the synthetic fluid jet can be deviated over a very wide angle, of almost 180°, because it can be deflected both towards the first Coanda surface and the second Coanda surface.

Furthermore, direction of the synthetic jet can be modified by simply acting on the momentum of the first jet and/or of the second jet, without using moving mechanical parts and without acting on a great number of control jets or pneumatic valves.

This makes controlling the synthetic jet particularly simple.

### BRIEF DESCRIPTION OF THE DRAWINGS

Further features and advantages of the present invention will emerge more clearly from the approximate and thus non-limiting description of a preferred, but not exclusive, embodiment of a system for controlling the angular deflection of a synthetic jet, as illustrated in the accompanying drawings, wherein:

FIG. 1 is a schematic sectional view of a nozzle according to the invention;

FIGS. 2/a, 2/b and 2/c are explanatory schemes explaining operation of the nozzle;

FIGS. 3/a and 3/b are sectional views of a nozzle made according to the present invention in a non-symmetrical configuration;

FIG. 4 shows the main geometrical dimensions of the nozzle;

FIGS. 5/a and 5/b show two possible configurations of the channels inside the present nozzle.

### DETAILED DESCRIPTION OF PREFERRED EMBODIMENTS OF THE INVENTION

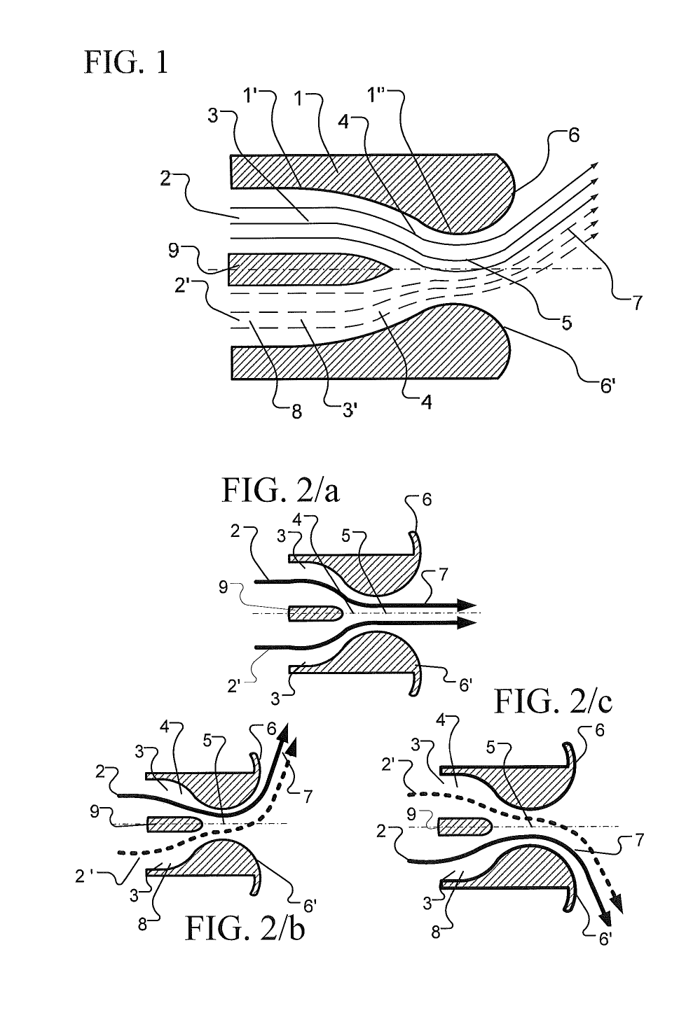

With particular reference to FIG. 1, (1) indicates a nozzle made according to the present invention and represented in a sectional view.

This nozzle is constituted by a conduit (8) divided in two half-conduits (3) and (3′) by a separation baffle (9). In other words, the separation baffle (9) divides the conduit (8) in a first channel (3) and in a second channel (3′).

The length of the separation baffle (9) can be arbitrarily chosen in a design phase.

A first fluid jet (2) can flow in the first channel (3), whereas a second fluid jet (2′) can flow in the second channel (3′). The fluid jets (2′) and (3′) can be considered as primitive jets intended to be mixed to one another in order to form a resulting jet or synthetic jet.

Inside the conduit (8) there is defined a zone (1′) designed for the fluid-dynamic stabilization of the primitive jets (2) and (2′), and a zone (1″) constituting a narrowing and leading into the outflow mouth (5), the walls of which are curved and are seamlessly connected to the walls of the half-conduits or channels (3) and (3′). It is also provided that the zones (1′) and (1″) be of arbitrary lengths, depending on the nature and inlet flow conditions of the primitive jets in the respective half-channels.

It is provided that the mixing zone (4) of the two flows (2) and (2′) precedes the outflow mouth (5) and is shaped as a bottleneck, the curved profile of which continues in two Coanda surfaces (6) and (6′) and joins together with the outer walls of the nozzle (1).

In other words, the nozzle (1) comprises, in an exit zone from which the synthetic jet (7) exits, a first Coanda surface (6) and a second Coanda surface (6′). The first Coanda surface (6) is arranged near the first channel (3) or half-conduit (3), whereas the second Coanda surface (6′) is arranged near the second channel (3′) or half-conduit (3′).

In particular, the first Coanda surface (6) is the continuation of a wall which delimits the first channel (3) at a side opposite the separation baffle (9). The second Coanda surface (6′) is the continuation of a further wall which delimits the second channel (3′) at the side opposite the separation baffle (9).

The first Coanda surface (6) faces the second Coanda surface (6′).

The outflow mouth (5) is in a plane in which the distance between the first Coanda surface (6) and the second Coanda surface (6′) has a minimum value.

It is further provided that the direction of the synthetic jet (7) is controllable by means of the momentums (or speeds for homogeneous jets) of the two primitive jets (2) and (2′) that feed the nozzle.

Optimal functioning of the system requires that the jets (2), (2′) and, thus, (7) be fast and this condition can be expressed by the Reynolds number of the synthetic jet (7), which must be no lower than 4000 and possibly higher than 10000.

FIGS. 2/a, 2/b and 2/c illustrate the behaviour of the flows when the ratio between the velocities (momentum) of the two jets (2) and (2′) varies. A properly proportioned nozzle is such that the synthetic jet (7) exiting from the outflow mouth (5) bends on the part of the jet having greater momentum. In particular, this jet (7) will be aligned with the axis of the outflow mouth (FIG. 2/a) in the case in which the jets have the same momentum, or it will adhere to one of the Coanda surfaces (6) and (6′) exiting the nozzle, adhering to the Coanda surface on the part of the jet having greater momentum (represented by the solid line). If the Coanda surfaces (6) and (6′) differ from each other, the angular deflection may differ for the two surfaces (6) and (6′).

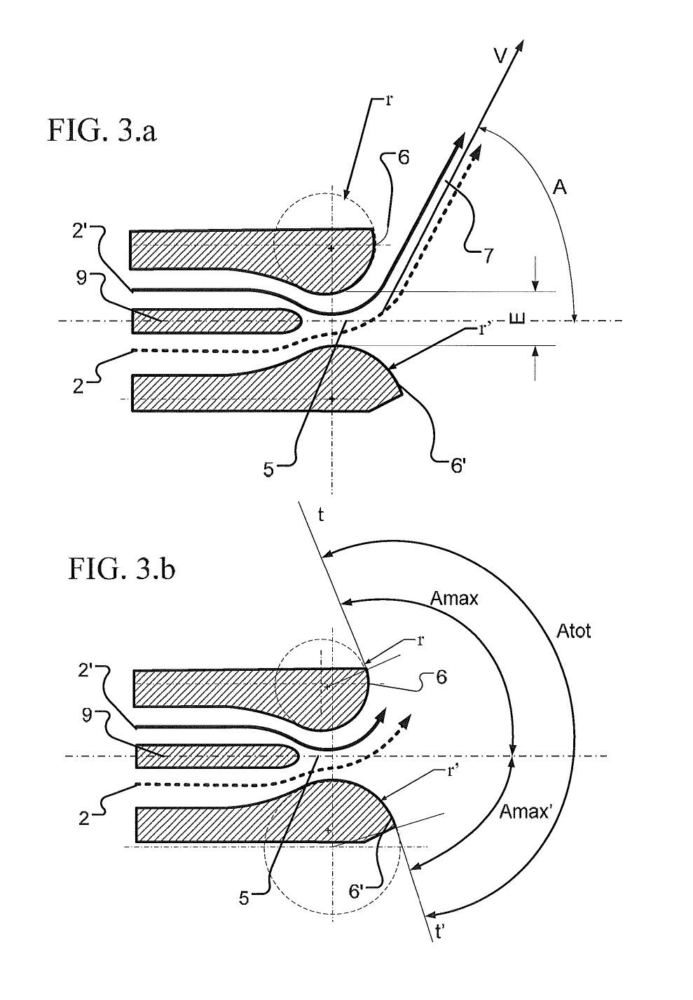

With reference to FIGS. 3/a and 3/b, the deviation angle of the synthetic jet (7) is defined, along with the possible geometrical features thereof.

FIG. 3/a is a plane section of a generic nozzle made according to the present invention with exiting Coanda surfaces that differ one from the other. In particular, the vector (V) indicates the direction of the synthetic jet and (A) is the angle that the direction (V) forms with the geometrical axis of the outflow mouth (5). The synthetic jet (7) adheres spontaneously to the Coanda surface on the part of the primitive jet having greater momentum (indicated by the thick solid line) until a certain detachment point. The vector (V) assumes the direction of the tangent to the Coanda surface at the detachment point, as identified by the angle (A) that the direction of the synthetic jet (7) forms with the axis of the outflow mouth (5). The angle (A) thus defined increases if the difference between the momentums of the primitive jets (2) and (2′) increases, decreases if this difference decreases, and becomes zero when there is no difference therebetween.

Lastly, the radii (r) and (r′) indicate the curvature of the Coanda surfaces (6) and (6′), and together with the thickness (E) of the outflow mouth (5), they represent the geometrical parameter that is most influential on the direction of the synthetic jet.

FIG. 3/b defines the physical and design limits affecting the above-mentioned angle (A). The maximum span of this angle (A) may vary between two maximum values Amax on the side of the surface (6) and Amax′ on the side of the surface (6′). The Amax and Amax′ angles are physically defined by the physical properties of the primitive jets, by their momentums, and by the radii of curvature of the surfaces (6) and (6′), but they can also be limited during the planning stages by introducing an abrupt interruption of the Coanda surfaces (6) and (6′). At such interruptions, the jet continues along the tangents (t) and (t′) to the Coanda surfaces (6) and (6′). The maximum sweep angle of the jet is comprised within the tangents (t) and (t′) with an angle span Atot equal to the sum of the spans of the angles Amax and Amax′.

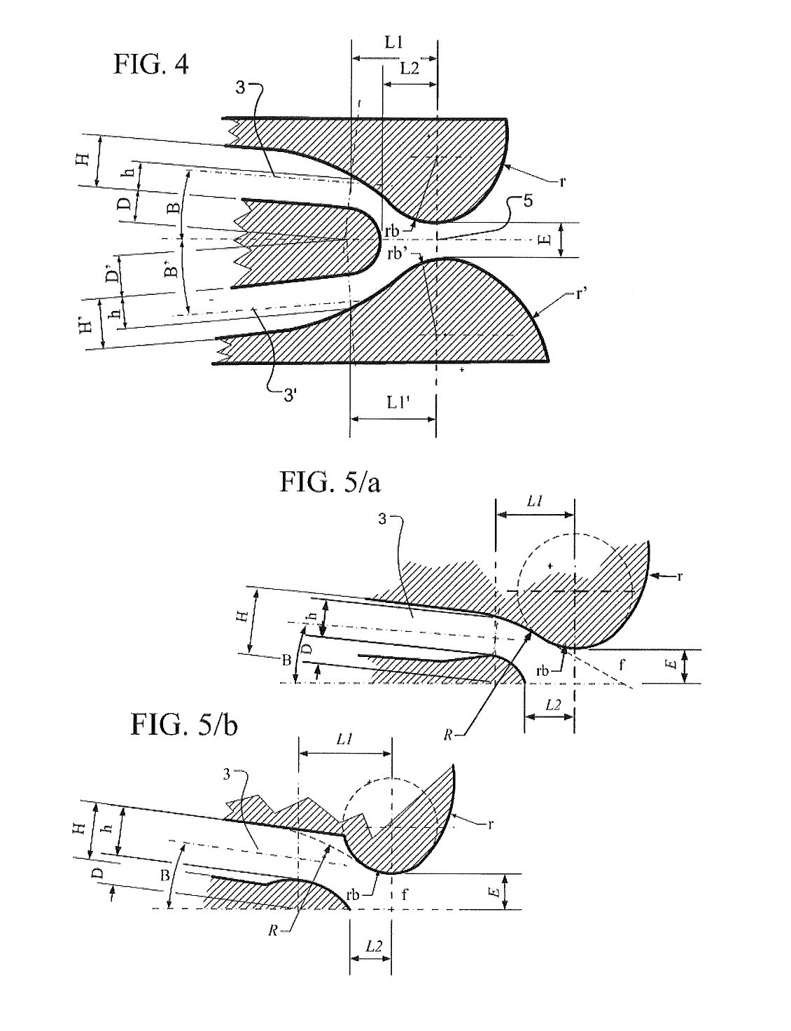

FIG. 4 represents a section of a generic nozzle with indications of the principal geometrical dimensions characteristic of the nozzle. In order to ensure optimal operation of the system and good mixing of the primitive jets (2) and (2′), the section of the half-conduits can decrease towards the outflow mouth (5), having an outlet section smaller in area with respect to the sum of the inlet sections of the primitive jets.

Considering a section of the nozzle such as the one represented in FIG. 4, the half-conduits or channels (3) and (3′) are designed in such a manner as to have initial sections (1) and (1′) of thicknesses (H) and (H′), with an arbitrary inclination (even none) indicated by the angles (B) and (B′) that the axes of the half-conduits form with the axis of the outflow mouth (5). The thicknesses of the half-conduits or channels (3) and (3′) narrow down because of the partition baffle and of the side walls of the nozzle. The dimensions (D) and (D′) represent the maximum thicknesses of the separation baffle according to the preferential directions of the half-conduits or channels. The thicknesses of the partition baffle at the start of the final narrowing of the separation baffle are (h) and (h′). The outflow mouth is defined by the curvature radii (rb) and (rb′) of the surfaces inside the nozzle and it tangentially joins the Coanda surfaces of radii (r) and (r′), and by its thickness (E).

Additional important geometrical parameters are the distances (L1) and (L1′) between the section in which the dimensions (h) and (h′), and the outflow mouth (5) are measured and also the distance (L2) between the final point of the partition baffle and the same outflow mouth, as measured parallel to the geometrical axis of the outflow mouth (5).

The separation baffle and the half-conduits or channels can be designed in such a manner as to ensure optimal mixing of the jets. To this end, no part of the baffle protrudes beyond the outflow mouth (5). The following geometrical relations are thus defined: the distances (L1) and (L1′) are greater than the distance (L2); the distance (L2) can be greater than, or equal to, half of the minimum thickness E of the outflow mouth; lastly, the sum of the thicknesses (H) and (H′) is greater than, or equal to, the thickness (E) of the outflow mouth.

FIGS. 5/a and 5/b show by way of example, two possible forms of the half-conduits or channels of the nozzle according to the present invention, for the purpose of unambiguously defining the geometrical features thereof.

FIG. 5/a shows the wall of the half-conduits or channels of the nozzle in the case in which the curvatures of the surfaces are tangentially joined in a seamless manner, offering the preferable solution in terms of fluid dynamics.

FIG. 5/b shows an example of a conformation of the nozzle in which the curvatures of the surfaces of the half-conduits or channels inside the nozzle are not smoothly joined to the curved surface that generates the outflow mouth of the nozzle. The fluid dynamics of the nozzle defines flow lines of a radius (R), determining a turbulence zone between the edges of the fluid flow and the walls of the half-conduits of channels, within a fluid dynamic conformation not unlike that appearing in FIG. 5/a.

The nozzle (1) does not have an axial-symmetric conformation, but rather a substantially flat conformation, and extends in a direction perpendicular to the plane of the Figures.

In particular, the separation baffle (9) can be substantially flat.

The separation baffle (9) is solid, i.e. it is not internally hollow.

The separation baffle (8) extends longitudinally inside the conduit (8).

It is further provided that the conformation of the nozzle, and thus of its walls, may have different geometrical and functional conformations, symmetrical or non-symmetrical, depending on the properties, the nature and the conditions of the primitive jets that must be mixed.

In any case, all the possible conformations of the system and the methodologies for the control thereof, are based on the variation of the direction of a synthetic jet formed by the mixing of two primitive jets, following any variation in the momentum of the constituent primitive jets.

The invention thus achieves the proposed objects as the system of deflection of a synthetic jet with the described features makes it possible to deviate a fluid jet with no moving mechanical parts.

The system is designed so as to be utilized above all in applications that may require angles of deviation of the jet, which may also vary over time, and as a results of its having no moving mechanical parts, wear is markedly reduced with respect to any other system of deviation of a fluid flow.

To summarize, the nozzle (1) according to the invention allows the mixing of two primitive jets (2) and (2′) which may be homogeneous (for example equal by nature, physical state and temperature), inhomogeneous, and may also suffer chemical and physical transformations as a result of mixing, forming a single synthetic jet (7) at the outlet.

The nozzle (1) allows to divert the synthetic jet (7) with no moving parts, by combining the mixing effects of the primitive jets (2) and (2′) and the adhesion effects of the synthetic jet to the Coanda surface (6) and (6′) protruding from the outflow mouth (5) of the nozzle owing to the Coanda effect.

The nozzle (1) comprises a zone (1′) of stabilization of the primitive jets (2) and (2′), a baffle (9) that separates these jets, a convergence zone (1″), an outflow mouth (5) which connects the outside with two convex surfaces (6) and (6′), called Coanda surfaces, with arbitrary radii (r) and (r′).

The nozzle (1) is divided in two half-conduits (3) and (3′) that narrow due to the dividing baffle and to the lateral walls of the nozzle so that the sum of their initial thickness D and D′ is greater than or equal to the thickness E of the outflow mouth (5).

The nozzle (1) is made by a conduit (8) divided by a separation baffle (9) in two hemi-conduits (3) and (3′), whose geometric axes form arbitrary angles (B) and (B′) with the axis of the outflow mouth (5), even equal to zero.

The nozzle (1) is divided in two half-conduits by a separation baffle (9) that does not protrude beyond the outflow mouth (5) and is at a distance (L2) from the outflow mouth (5) greater than or equal to half the thickness of the outflow mouth (E).

The nozzle (1) is capable of deflecting a synthetic jet (7) formed by two primitive jets (2) and (2′) so that the vector (V), which identifies the direction of the synthetic jet, is directed on the side of the primitive jet with higher momentum.

The nozzle (1) allows to keep constant the angle of deviation (A) of a synthetic jet (7) if the momentum of the primitive jets is maintained constant and to modify the angle (A) by varying the momentum of primitive jets.

The nozzle (1) allows to increase the angle of deviation (A) of a synthetic jet (7) by increasing the difference between the momentums of two primitive jets (2) and (2′) that form the synthetic jet, to decrease the angle of deviation (A) by decreasing said difference and to make the angle of deviation (A) null by making said difference equal to zero.

The nozzle (1) allows to control the deviation angle (A) of a synthetic jet (7) by varying the momentums of the primitive jets (2) and (2′) that form it.

The nozzle (1)—without limiting elements—keeps the deviation angle (A) of a synthetic jet (7) within the physical limits of adhesion of the synthetic jet (7) to the Coanda surfaces (6) and (6′) that depend on the fluid, on the momentum and on the shape of the Coanda surfaces.

The nozzle (1) allows to limit the deviation angle (A) of a synthetic jet (7) by means of arbitrary interruptions of the Coanda surfaces (6) and (6′), beyond which a synthetic jet which remained attached to them can proceed only assuming the direction identified by the tangents (t) and (t′) to the Coanda surfaces at such interruptions.

1. A nozzle comprising:
a conduit divided into a first channel in which a first jet of a fluid can flow and into a second channel in which a second jet of a fluid can flow;
a convergence zone for converging the first jet and the second jet one towards another, so as to obtain a synthetic jet;
an exit zone through which the synthetic jet can exit the nozzle;
wherein the exit zone is delimited by a first Coanda surface and by a second Coanda surface, the first Coanda surface being arranged in a position adjacent the first channel and the second Coanda surface being arranged in a position adjacent the second channel, so that the first jet adheres to the first Coanda surface and drags the second jet or, alternatively, the second jet adheres to the second Coanda surface and drags the first jet.

2. A nozzle according to claim 1, wherein, in the convergence zone, the conduit has a cross-section which narrows towards the exit zone.

3. A nozzle according to claim 1, and further comprising an outflow mouth in which the first Coanda surface and the second Coanda surface are arranged at a minimum distance one from another.

4. A nozzle according to claim 3, and further comprising a stabilization zone defined in the first channel and in the second channel for stabilizing the first jet and the second jet from a fluid-dynamic point of view, the stabilization zone being arranged upstream of the convergence zone, the convergence zone ending at the outflow mouth.

5. A nozzle according to claim 1, and further comprising a separation baffle for separating the first channel from the second channel.

6. A nozzle according to claim 5, wherein the separation baffle is solid, i.e. non-hollow.

7. A nozzle according to claim 5, wherein the first Coanda surface is provided as a continuation of a wall of the conduit which delimits the first channel opposite the separation baffle, the second Coanda surface being provided as a continuation of a further wall of the conduit which delimits the second channel opposite the separation baffle.

8. A nozzle according to claim 5, and further comprising an outflow mouth in which the first Coanda surface and the second Coanda surface are arranged at a minimum distance one from another, wherein the separation baffle does not protrude beyond the outflow mouth.

9. A nozzle according to claim 5, and further comprising an outflow mouth in which the first Coanda surface and the second Coanda surface are arranged at a minimum distance one from another, wherein the separation baffle has an end arranged at a preset distance from the outflow mouth, said preset distance being greater than, or equal to, half the minimum distance between the first Coanda surface and the second Coanda surface.

10. A nozzle according to claim 5, wherein the first channel and the second channel have, at a side of the separation baffle opposite the exit zone, respective initial thicknesses, the sum of said initial thicknesses being greater than, or equal to, the minimum distance between the first Coanda surface and the second Coanda surface.

11. A nozzle according to claim 1, wherein the first channel and the second channel define respective passage sections for the first jet and the second jet, said respective passage sections narrowing towards the exit zone.

12. A nozzle according to claim 1, wherein the first Coanda surface and the second Coanda surface are convex surfaces having arbitrary curvature radii.

13. A nozzle according to claim 1, wherein the first Coanda surface and/or the second Coanda surface arranged in the exit zone have an abrupt interruption along their extension, so that the synthetic jet which adheres to the first Coanda surface or to the second Coanda surface proceeds beyond the first Coanda surface or the second Coanda surface along a direction defined by the tangent to the first Coanda surface or the second Coanda surface at said interruption.

14. A method comprising:
sending a first jet of a fluid through a first channel of a conduit of a nozzle;
sending a second jet of a fluid through a second channel of the nozzle;
mixing the first jet and the second jet to obtain a synthetic jet;
causing the synthetic jet to pass through an exit zone of the nozzle, the exit zone being delimited by a first Coanda surface and by a second Coanda surface, the first Coanda surface being arranged in a position adjacent the first channel and the second Coanda surface being arranged in a position adjacent the second channel;
wherein:
if the first jet has a momentum greater than the second jet, the first jet adheres to the first Coanda surface and drags the second jet;
if the second jet has a momentum greater than the first jet, the second jet adheres to the second Coanda surface and drags the first jet.

15. A method according to claim 14, and further comprising the step of modifying the momentum of the first jet and/or of the second jet in order to vary direction of the synthetic jet.
